(19) United States
(12) Patent Application Publication
(10) Pub. No.: US 2008/0187263 A1
(43) Pub. Date: Aug. 7, 2008

(54) Roller Bearing With A Window Cage With Positioning Elements In The Bearing Pockets For Altering The Pocket Play By Means Of Temperature-Dependent Change In Shape Of The Positioning Elements For Example By Means Of Shape Memory Alloy

(75) Inventors: Joerg Spielfeld, Schweinfurt (DE); Stefan Glueck, Niederwerrn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/913,515

(22) PCT Filed: Apr. 28, 2006
(86) PCT No.: PCT/DE06/00740

§ 371 Date: Dec. 13, 2007

(30) Foreign Application Priority Data
May 4, 2005 (DE) 10 2005 020 782.0

(51) Int. Cl. F16C 33/42; F16C 33/44

(52) U.S. Cl. 384/523; 384/527

(57) ABSTRACT

The invention relates to a roller bearing, with an inner running ring, an outer running ring, several roller bodies, arranged between the running rings and guided in a bearing cage, whereby the bearing cage comprises circumferential evenly distributed bearing pockets which are essentially axially and circumferentially enclosed, and each of which contains a roller body. According to the invention, the operational characteristics of the roller bearing may be improved whereby on each bearing pocket the bearing cage comprises at least one passive positioning element by means of which the pocket play of the corresponding roller body may be altered due to a temperature-dependent shape change of the positioning element.

### FIELD OF THE INVENTION

The invention relates to a roller bearing, having an inner running ring, an outer running ring, a plurality of roller bodies which are arranged between the running rings and guided in a bearing cage, wherein the bearing cage has bearing pockets for holding the roller bodies, which bearing pockets are arranged distributed evenly over the circumference, which are largely closed axially and circumferentially and each contain one of the roller bodies.

### BACKGROUND OF THE INVENTION

A roller bearing is composed, in a simple embodiment, of two running rings, the inner running ring and the outer running ring, between which roller bodies are arranged in a bearing cage. When there is a relative rotation of the inner running ring with respect to the outer running ring, the roller bodies roll on the raceways of the running rings. In this context, the roller movement of the roller bodies is composed of a rolling movement and a sliding movement on the raceways of the running rings, wherein the rolling movement predominates and ensures a very much smaller frictional resistance compared to a pure sliding movement. As a result of the bearing cage, the roller bodies are guided evenly distributed over the circumference and spaced apart from one another between the running rings, as a result of which uniform loading of the bearing components over the circumference, round and quiet running, a low degree of wear and/or a long service life and a low rotational resistance of the roller bearing are achieved.

A bearing cage which is provided with largely closed bearing pockets can be manufactured from different materials and semi-finished products such as sheet steel, metal wire or plastic, and embodied in various designs.

DE 197 26 825 A1 describes, for example, a bearing cage of a roller bearing which is formed from a cage ring with bearing pockets which are open axially on one side, and with an annular disk-shaped end cap which, after the insertion of the roller bodies, is fitted onto the open side of the cage ring and is connected thereto by means of self-cutting screws.

DE 21 50 982 A1 discloses, on the other hand, a bearing cage of a roller bearing which is manufactured completely from a metal wire. The metal wire is shaped to form two U-shaped wire straps for holding the roller bodies, the distance between which wire straps is smaller than the diameter of the roller bodies whose limbs are arranged above and below the equator of the roller bodies and the distance between said limbs is smaller than the diameter of the roller bodies, while in each case the two straps which hold one of the roller bodies are connected to one another at one of their ends and are connected to the straps of the adjacent roller bodies at their other end.

In another known design, a bearing cage is composed of two symmetrical cage rings made of sheet steel with half pockets which are in the shape of half rings or half shells, are axially open toward the insides, and bear against one another and are riveted to one another centrally in the axial direction and circumferentially, on each side of the bearing pockets. Furthermore, roller bearings are known with bearing cages which are manufactured in one piece with closed bearing pockets as injection molded parts made of a plastic such as, for example, polyamide.

Although a bearing cage which is composed of plastic has a relatively low friction with the roller bodies in the bearing pockets compared to designs made of sheet steel or metal wire. However, a disadvantage is the relatively high level of wear of the plastic in the frictional contact with the roller bodies and the relatively low resistance to heat or relatively low maximum permissible operating temperature of the cage material. For this reason, roller bearings which are mechanically and thermally highly stressed are predominantly provided with bearing cages which are manufactured from metal components.

However, all bearing cages which are composed of metal basically have the disadvantage that the pocket air in the bearing pockets, that is to say the circumferential and axial distance between the roller bodies and the web elements and ring elements of the roller body cage, has previously been impossible to influence selectively, which would be desirable, for example, in order to adapt it to specific mechanical and thermal stresses. For example, a large amount of pocket air is advantageous to achieve a low starting resistance at the start of the operating phase of a machine or of a vehicle. However, said pocket air should then quickly become smaller as the rotational speed and load on the roller bearing increase, and should be kept constant as the mechanical and thermal loads rise further, in order to avoid, on the one hand, oscillating movements of the roller bodies in the bearing pockets, and thus increased wear and noise from the roller bearing, and, on the other hand, excessively high friction between the roller bodies and the bearing cage. However, in fact with many roller bearings the pocket air becomes smaller due to different thermal expansion rates of the running rings, of the roller bodies and of the bearing cage as the operating temperature increases, which leads to increased bearing resistance, greater wear and a reduced service life of the roller bearings in question.

### OBJECT OF THE INVENTION

he invention is therefore based on the object of developing a roller bearing of the type mentioned at the beginning in the simplest and most cost-effective way in order to provide improved operating properties.

### SUMMARY OF THE INVENTION

The invention is based on the realization that automatic, load-dependent modification or setting of the pocket air of the roller bodies and thus adaptation of the respective roller bearing to the instantaneous load is possible by arranging passive actuating elements, which are effective in a temperature-dependent fashion, on the bearing pockets of the bearing cage. In this context, for the passive control of the actuating elements it is possible to make use of the fact that the operating temperature of the roller bearing rises due to friction as the load increases. Furthermore, it is also possible to influence actively the setting of the pocket air and thus the bearing resistance of the roller bearing by arranging a heating or cooling element in the vicinity of the location at which a roller bearing is installed.

The object of the invention is therefore achieved according to the invention in conjunction with the features of the preamble of claim 1 by virtue of the fact that the bearing cage has, on each of the bearing pockets, at least one passive actuating element which can be used to modify the pocket air of the assigned roller body by a temperature-dependent change in the shape of the respective actuating element.

Advantageous refinements of the roller bearing according to the invention are the subject matter of claims 2 to 7.

The arrangement of the passive actuating elements on the bearing pockets of the bearing cage allows the pocket air of the roller bodies to be increased, reduced or kept constant as the load increases, which is associated with a rise in temperature, without an external control effect; and this is done as a function of the specific application and the desired interaction and by virtue of a corresponding geometric embodiment and arrangement of the actuating elements. An appropriate configuration of the actuating element allows the temperature-dependent change in the shape to comprise extension of the actuating element, bending of the actuating element or a combination of the two. An alloy with a shape memory, in particular a nickel/titanium alloy, is preferably used for the actuating elements, said actuating elements being composed at least partially of said alloy depending on the design. Shape memory alloys have significantly larger modifications of their shape, that is to say extension and/or bending, than other known materials for passive actuating elements which are used for extension elements and bimetal elements, and at the same time said alloys have a high mechanical and thermal load-bearing capability.

The modifications of the shape of the shape memory alloys are caused by ternal structural changes between martensite and austenite, which occur in a relatively small temperature range. For this reason, shape changing alloys are suitable in particular for use in passive actuating elements with applications with temperature-dependent functions.

For example, applications in thermostat valves of engine cooling systems and in the fan couplings of brake systems of motor vehicles are already known. Likewise, JP 062 00933 A, JP 63009720 A and JP 01060243 A have, for example, also disclosed components made of alloys with a shape memory for temperature-dependent influencing of the axial or radial installation play of roller bearings. Nickel/titanium alloys are particularly well suited to such applications since their structural conversion takes place in the temperature range from −35° C. to +85° C. which occurs frequently in practical operational use. Nickel/titanium alloys also have good damping properties which leads to an improvement in running smoothness when they are applied in roller bearings.

In a first embodiment of a roller bearing according to the invention, the actuating element is embodied as a wire strap which is arranged in an assigned internal groove, oriented essentially circumferentially, of an axial side wall of the bearing pocket. The wire strap can be anchored at its ends in the internal groove and emerges between those ends from the internal groove to a greater or lesser extent as a function of the temperature, and this essentially controls the axial pocket air.

Likewise, the wire strap can be anchored centrally in the internal groove and then emerges from the internal groove with its ends to a greater or lesser extent as a function of the temperature, and this essentially controls the circumferential pocket air.

Furthermore, in a flexibly weak axial side wall of the bearing pocket it is also possible for the wire strap to be anchored completely in the internal groove, and the side wall then deforms elastically as a function of the operating temperature, as a result of which both the axial and circumferential pocket air can be controlled.

In a second embodiment of a roller bearing according to the invention, the actuating element is embodied as a wire strap which is clamped so as to extend it between the axial side walls of the bearing pocket before and/or after the roller body in the rotational direction, within the bearing pocket. If, for example in the case of a roller body which is embodied as a ball, the wire strap is embodied in an arcuate shape corresponding to the contour of the ball, the circumferential pocket air is essentially reduced by temperature-dependent shortening and straightening of the wire strap, and is increased by lengthening and further arcing of the wire strap.

In a third embodiment which can be applied in a roller bearing whose bearing cage is riveted and is composed of two cage rings which are connected by means of rivet elements, the rivet elements are embodied as actuating elements. In this context, the rivet elements may be effective as pure extension elements, and this gives rise to a temperature-dependent modification of the axial pocket air due to a variable axial distance between the two cage rings. However, it is also possible for the rivet elements to be additionally or alternatively embodied as bending elements, and this permits a variable radial and/or circumferential offset between the two cage rings and thus a temperature-dependent modification of the circumferential pocket air.

The above-mentioned embodiments for controlling the pocket air of a roller bearing as a function of the temperature can respectively be used individually or in combination with one another.

### BRIEF DESCRIPTION OF THE DRAWINGS

The invention will be explained in more detail below with reference to the appended drawings and using a number of embodiments. In particular, in this context:

FIG. 1 shows a first embodiment of a roller bearing according to the invention, by way of a detail of a riveted bearing cage of a ball bearing;

FIG. 2 shows a second embodiment of a roller bearing according to the invention, by way of a detail of a bearing cage of a ball bearing;

FIG. 3 shows the embodiment according to FIG. 2, by way of a detail of a bearing cage of a cylinder roller bearing; and

FIG. 4 shows a third embodiment in a detail of a riveted bearing cage of a ball bearing.

### DETAILED DESCRIPTION OF THE DRAWINGS

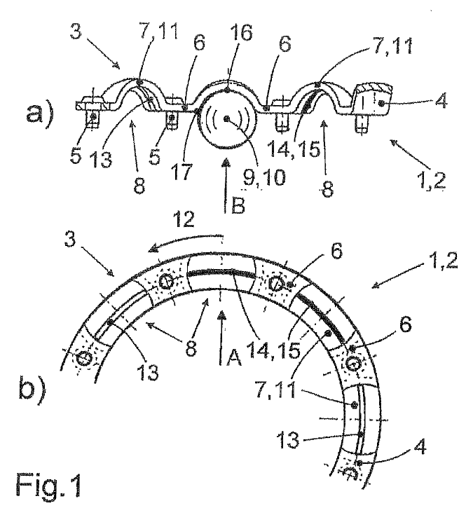

A roller bearing 1 which is embodied as a ball bearing 2 and is illustrated in FIG. 1 as a detail in a radial view A in the partial FIG. 1a, and in an axial view B in the partial FIG. 1b, has a riveted bearing cage 3 which is composed of two symmetrical cage rings 4 which are connected by means of rivet elements 5. The cage rings 4 have, distributed uniformly over the circumference, a pocket section 7 which is hollowed out in an axially arcuate shape, each between two connecting webs 6. In the mounted state of the bearing cage 3, the pocket sections 7 of the cage rings 4 which are riveted to one another form closed bearing pockets 8 which are arranged distributed evenly over the circumference and in each of which a roller body 9 which is embodied here as a ball 10 is arranged.

According to the invention, the pocket sections 7, which are essentially effective as axial side walls 11 of the bearing pockets 8, each have on their inner side an internal groove 13 which is circumferential, that is to say oriented in the rotational direction 12 of the roller bearing 1 and in which a temperature-sensitive, passive actuating element 14, embodied as a wire strap 15, is arranged. The actuating elements 14 are preferably composed at least partially of an alloy with a shape memory, in particular a nickel/titanium alloy, and therefore have a temperature-dependent modification of shape or temperature-dependent extension and/or bending, as a result of which the axial and/or the circumferential pocket air 16, 17 is automatically reduced, increased or kept constant as the operating temperature rises.

By way of a suitable embodiment of the actuating elements 14 it is possible to adapt the operating properties of the roller bearing 1 automatically to the current operating conditions as a function of the temperature. The arrangement of a heating or cooling element (not shown here) in the vicinity of the location where the roller bearing 1 is installed also permits the pocket air 16, 17, and thus the bearing resistance of the roller bearing 1, to be influenced actively.

If the wire straps 15 are each anchored at their ends in the respective internal groove 13, they emerge centrally from the internal groove 13 to a greater or lesser extent as a function of the operating temperature, as a result of which essentially the axial pocket air 16 is controlled. When there is central anchoring in the internal grooves 13, the wire straps 15 emerge with their ends from the internal grooves 13 to a greater or lesser extent as a function of the temperature, as a result of which essentially the circumferential pocket air 17 is controlled. Furthermore, when there are flexibly weak axial side walls 11, the wire straps 15 can also be anchored completely in the internal grooves 13 and deform them elastically as a function of the temperature, as a result of which both the axial and the circumferential pocket air 16, 17 can be controlled.

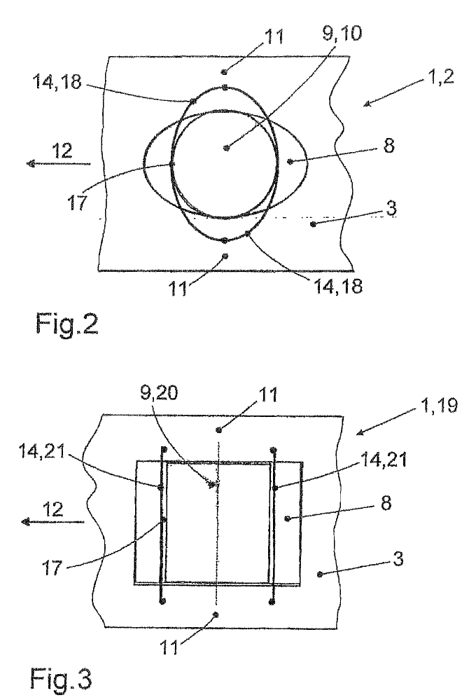

FIG. 2 is a radial view of a detail of a roller bearing 1 which is embodied as a ball bearing 2 and in which a roller body 9, which is embodied as a ball 10, is arranged in a bearing pocket 8 of a bearing cage 3 of any desired design. Within the bearing pocket 8 which has an elliptical cross section, a temperature-sensitive passive actuating element 14 is arranged in front of and behind the ball 10 in the rotational direction 12, said actuating element 14 being embodied as an arcuate wire strap 18 and being clamped so that it extends between the axial side walls 11 of the bearing pocket 8.

The actuating elements 14 are composed at least partially of an alloy with a shape memory such as a nickel/titanium alloy, and they therefore have a temperature-dependent modification of shape, that is to say extension and/or bending, which is expressed here essentially in the form of shortening or lengthening of the wire straps 18, and thus entails the arcuate hollowing-out of the wire straps 18 and hence the circumferential pocket air 17 in the ball 10 being reduced, enlarged or kept constant. As a result, if the actuating elements 14 are embodied appropriately, this embodiment also permits the operating properties of the roller bearing 1 to be adapted automatically to the current operating conditions as a function of the temperature.

FIG. 3 is a radial view of a detail of a roller bearing 1 which is embodied as a cylinder roller bearing 19 and in which a roller body 9 which is embodied as a cylinder roller 20 is arranged in a bearing pocket 8 of a bearing cage 3 of any desired design. Within the bearing pocket 8 which has a rectangular cross section, a temperature-sensitive passive actuating element 14, which is embodied as a straight wire strap 21 and is clamped so as to extend between the axial side walls 11 of the bearing pocket 8, is arranged in front of and behind the cylinder roller 20 in the rotational direction 12.

These actuating elements 14 are also composed at least partially of an alloy with a shape memory, in particular of a nickel/titanium alloy. The temperature-dependent interaction is similar to that which has already been described with reference to FIG. 2, with the wire straps 21 moving outward essentially circumferentially starting from the straight state illustrated in FIG. 3 as the temperature rises due to increased thermal expansion relative to the other components 3, 20 so that the circumferential pocket air 17 in the cylinder roller 20 is increased or at least kept constant.

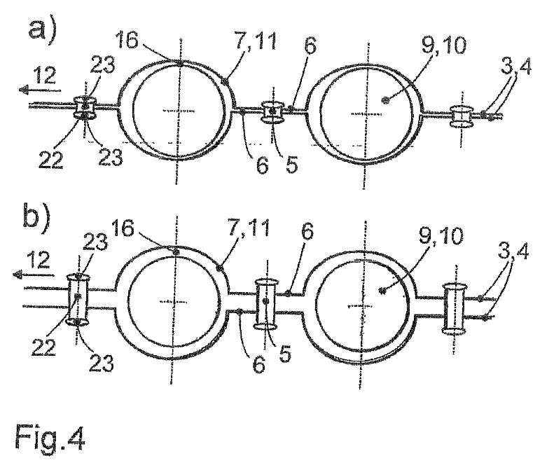

The roller bearing 1, of which a detail is shown in FIG. 4 in radial views in the partial FIGS. 4a and 4b, is embodied in a similar way to that according to FIG. 1 as a ball bearing 2 with a riveted bearing cage 3. The two cage rings 4 are, however, now connected to one another by means of rivet elements 5 which are embodied as temperature-sensitive passive actuating elements 14 and are composed at least partially of an alloy with a shape memory, such as a nickel/titanium alloy. Starting from the state illustrated for a first temperature T1 in the partial FIG. 4a, in which state the connecting webs 6 of the cage rings 4 are pressed together axially due to the short rivet stems 22 of the rivet heads 23 of the rivet elements 5, the rivet stems 22 of the rivet elements 5 are lengthened in the illustration in the partial FIG. 4b which applies for a second temperature T2, with the result that the cage rings 4 are spaced apart from one another axially at the connecting webs 6, which leads predominantly to enlargement of the axial pocket air 16 of the balls 10.

Alternatively or additionally, the rivet elements 5 can, however, also be embodied as actuating elements 14 with predominantly temperature-dependent bending so that a change in temperature would result in a circumferential offset of the cage rings 4 and entail a modification of the circumferential pocket air 17 of the balls 10.

### LIST OF REFERENCE NUMERALS

1 Roller bearing
2 Ball bearing
3 Bearing cage
4 Cage ring
5 Rivet element
6 Connecting web
7 Pocket section
8 Bearing pocket
9 Roller body
10 Ball
11 Axial side wall
12 Rotational direction
13 Internal groove
14 (Passive) actuating element
15 Wire strap
16 Axial pocket air
17 Circumferential pocket air
18 Wire strap
19 Cylinder roller bearing
20 Cylinder roller
21 Wire strap
22 Rivet stem
23 Rivet head

1. A roller bearing, comprising an inner running ring, an outer running ring, a plurality of roller bodies which are arranged between the running rings and guided in a bearing cage, wherein the bearing cage has bearing pockets for holding the roller bodies, which bearing pockets are arranged distributed evenly over the circumference, are largely closed axially and circumferentially and each contain one of the roller bodies, characterized in that the bearing cage has, on each of the bearing pockets, at least one passive actuating element by means of which the pocket air of the assigned roller body can be modified by a temperature-dependent change in the shape of the actuating element.

2. The roller bearing as claimed in claim 1, comprising the temperature-dependent change in shape comprises extension and/or bending of the actuating element.

3. The roller bearing as claimed in claim 1, wherein the actuating element is composed at least partially of an alloy with a shape memory.

4. The roller bearing as claimed in claim 3, wherein the alloy with the shape memory of the actuating element is embodied as a nickel/titanium alloy.

5. The roller bearing as claimed in one of claim 1, wherein the actuating element is embodied as a wire strap which is arranged in an assigned internal groove, oriented essentially circumferentially, of an axial side wall of the bearing pocket.

6. The roller bearing as claimed in claim 1, wherein the actuating element is embodied as a wire strap which is clamped so as to extend between the axial side walls of the bearing pocket before and/or after the roller body in the rotational direction, within the bearing pocket.

7. The roller bearing as claimed in claim 1, wherein in the case of a riveted bearing cage which is composed of two cage rings which are connected by means of rivet elements, the actuating element is embodied as a rivet element.
